(19) United States
(12) Patent Application Publication
(10) Pub. No.: US 2011/0246062 A1
(43) Pub. Date: Oct. 6, 2011

(54) MAP AND DIRECTIONS SYSTEM WITH VERTICAL DISTANCE

(76) Inventor: Wesley W. Whitmyer, JR., Stamford, CT (US)

(21) Appl. No.: 13/082,779

(22) Filed: Apr. 8, 2011

(51) Int. Cl. G01C 21/00

(52) U.S. Cl. 701/201; 701/200

(57) ABSTRACT

A mapping and directions system including a processor, software executing on the processor for receiving a geographical origin, software executing on the processor for receiving a geographical destination, software executing on the processor for generating a travel route from the origin to the destination, the travel route including at least one ground-level travel portion and at least one vertical travel portion, and software executing on the processor for calculating a travel time for the travel route from the origin to the destination.

### FIELD OF THE INVENTION

The invention relates to map and directions systems, and more specifically to a system and method for providing maps and directions which take into account vertical distances including building heights.

### BACKGROUND OF THE INVENTION

Computerized mapping systems have been developed for facilitating travel planning. For example, travel-planning Internet websites are commercially available and well-known. Such websites typically permit a user to input a starting point and an end point for travel, and then calculate and provide travel directions to the user. For example, U.S. Pat. No. 7,239,959 to Rasmussen et al. discloses a system in which a user inputs start and end addresses and receives step-by-step travel directions via a web browser. However, such websites typically only provide directions from one address to another and do not consider additional travel time required once the user arrives at the location.

U.S. Pat. No. 6,374,182 to Bechtolsheim et al. discloses a navigation system that provides information about walking to a final destination in combination with information about driving toward the final destination. In particular, the system provides driving direction to parking near a final destination and walking directions from the parking location to the final destination. However, the Bechtolsheim patent only uses street addresses and does not use the precise destination at the endpoint, such as the particular floor or office in a building. Thus, time spent walking within the final destination, including time in elevators or on escalators, is not accounted for. Depending on the size of the building, the travel time once at the street address can be significant.

U.S. Pat. No. 6,542,811 to Doi discloses a walking navigation apparatus and method. The Doi patent discloses inputting a departure location, a destination, and route preferences of the walker. The apparatus and method uses road data and supplemental data, representing at least one of stairs, an elevator, an escalator, a step, and road width, to generate a route based on route preferences of the walker. For example, if the walker would like to avoid stairs, the apparatus and method generates a route without stairs. However, the Doi patent does not disclose calculating the additional time necessary for travel on elevators, escalators, or stairs, and does use a final destination within a building, such as the particular floor or office in the building.

U.S. Pat. No. 6,259,990 to Shojima et al. discloses a route guidance apparatus which provides information to guide users through the interior of a building to reach a target location. However, to do so, the apparatus requires markers, such as beam emitters, located throughout the inside of the building. The user must also carry the apparatus on his/her person to interface with the markers and guide the user to the target location. Moreover, the system disclosed in Shojima does not provide an estimated travel time.

It is therefore desired to provide a system to provide directions and an estimated travel time from an origin to a destination which takes into account travel time at the origin and destination including vertical travel time within buildings.

### SUMMARY OF THE INVENTION

Accordingly, it is an object of the present invention to provide a mapping and directions system which generates travel directions including ground-level and vertical travel portions and a total time to travel over each of the ground-level and vertical travel portions.

These and other objectives are achieved by providing a mapping and directions system including a processor, software executing on the processor for receiving a geographical origin, software executing on the processor for receiving a geographical destination, software executing on the processor for generating a travel route from the origin to the destination, the travel route including at least one ground-level travel portion and at least one vertical travel portion, and software executing on the processor for calculating a travel time for the travel route from the origin to the destination. The vertical travel portion may include, for example, at least one of elevator travel and escalator travel.

In some embodiments, the system may further include software executing on the processor for providing a visual display of the travel route and the travel time. To convey the vertical distances and account for the additional travel time required, one or more distances in the ground-level portion of the travel route may be enlarged in scale in the visual display to represent additional distance and time to travel the at least one vertical portion. In some embodiments, the destination includes a particular floor in a building, wherein the visual display includes a representation of a footprint of the building. The footprint of the building is enlarged in scale in the visual display in proportion to at least one of the travel time and travel distance required to reach the particular floor. The visual display may further include a three-dimensional representation of the building.

In some embodiments, the system includes a map database in communication with the processor, wherein the software for generating the travel route receives map data from the map database. The maps database may include data indicative of vertical travel features in one or more buildings including types of the vertical travel features and speeds of the vertical travel features.

The system may output the travel route and travel times to a computer via the Internet, or to a mobile device. In some embodiments, the software for receiving the geographical origin receives the origin from a global positioning system receiver in the mobile device.

Further provided is a mapping and directions system, including a processor, software executing on the processor for generating travel directions, including a travel route and a travel time, from a geographical origin to a geographical destination, the travel directions including at least one ground-level travel portion and at least one vertical travel portion, software executing on the processor for generating a visual display of the travel directions, wherein one or more features on the visual display of the travel route are enlarged in scale in proportion to at least one of a distance and a portion of the travel time required to travel the at least one vertical portion of the travel route.

Other objects of the present invention are achieved by provision of a method of providing travel directions, including the steps of receiving an origin, receiving a destination, generating a travel route from the origin to the destination, the travel route including at least one ground-level travel portion and at least one vertical travel portion, calculating a travel time for the travel route from the origin to the destination, and providing a visual representation of the travel route, including the ground-level travel portions and the vertical travel portions, and the travel time to a user via a user interface. In some embodiments, the step of calculating the travel time includes receiving data indicative of vertical travel features in one or more buildings. In some embodiments, the visual representation also includes one or more ground-level features enlarged in scale in proportion to at least one of a distance and a time required to travel the at least one vertical portion of the travel route.

Other objects of the invention and its particular features and advantages will become more apparent from consideration of the following drawings and accompanying detailed description.

### BRIEF DESCRIPTION OF THE DRAWINGS

FIG. 1 illustrates a system according to an exemplary embodiment of the present invention.

FIG. 2 illustrates a system according to an exemplary embodiment of the present invention.

FIG. 3 illustrates an exemplary display of a travel route generated by the system of FIGS. 1 and 2.

FIG. 4A illustrates an exemplary display of a travel route generated by the system of FIGS. 1 and 2.

FIG. 4B illustrates an exemplary display of a travel route generated by the system of FIGS. 1 and 2.

FIG. 5A illustrates an exemplary display of a travel route generated by the system of FIGS. 1 and 2.

FIG. 5B illustrates an exemplary display of a travel route generated by the system of FIGS. 1 and 2.

FIG. 6 illustrates an exemplary display of a travel route generated by the system of FIGS. 1 and 2.

FIG. 7A illustrates an exemplary display of a travel route generated by the system of FIGS. 1 and 2.

FIG. 7B illustrates an exemplary display of a travel route generated by the system of FIGS. 1 and 2.

FIG. 8 illustrates a method according to an exemplary embodiment of the present invention.

### DETAILED DESCRIPTION OF THE INVENTION

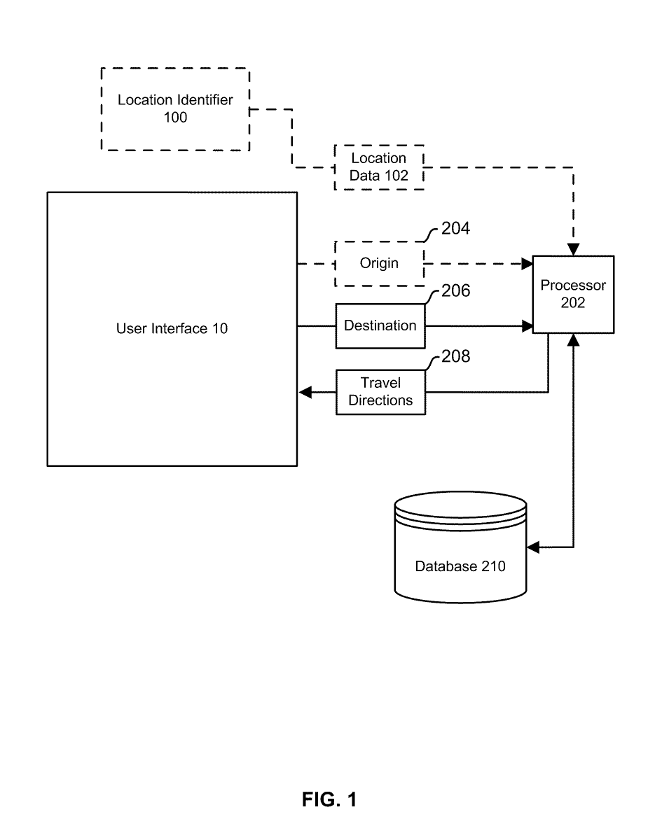

FIG. 1 illustrates an exemplary mapping and directions system according to the present invention. In the embodiment shown, the system includes a user interface 10 in communication with a processor 202. The user interface 10 may be embodied in software, hardware, or a combination of both. For example, the user interface 10 may include a display device, a digital display and interface generated by the system, and/or one or more input devices such as a touch screen, keyboard and/or mouse. The processor 202 of the system may be included in hardware associated with the user interface 10 and/or a client device, or may be remotely accessible thereto.

The system of FIG. 1 generates travel directions 208 from an origin 204 to a destination 206. The origin 204 may be entered by a user and received via the user interface 10, or determined by system. For example, in some embodiments, location data 102 indicative of the current location of the user is provided to the processor 202 from a location identifier 100 and used by the system to determine the origin 204. The location identifier 100 may be device based system such as a global position system (“GPS”) receiver or any other location identifying means (e.g., cell identification and/or triangulation). Data indicative of the destination 206 is provided from the user interface 10 to the processor 202. The destination 206 may, for example, be entered by a user of the system via the user interface 10.

The travel directions 208 are generated by software executing on the processor and sent to the user interface 10. In particular, the system includes software executing on the processor 202 for generating a travel route from the origin 204 to the destination 206, and software executing on the processor for calculating a travel time for the travel route. The resulting travel directions 208 may include a text and/or visual route from an origin 204 to the destination 206 together with a travel time.

Travel directions 208 generated by the system may include at least one ground-level travel portion and at least one vertical travel portion. For example, the system may be used to obtain travel directions from an origin to a destination with a building, such a particular floor or particular office and/or location within a building. The system generates travel directions, including a travel route and time, from the origin to the destination which includes ground-level travel to the general location of the destination and one or more vertical and/or horizontal travel portions at the destination. The vertical travel portion may include elevator travel, escalator travel, and travel up/down stairs. The ground-level travel times may be calculating by any means known in the art including but not limited to calculating a time based on the distance (e.g., as measured by street maps) and a travel speed (e.g., according to published speed limits, average walking speeds, etc.). The vertical travel time may be determined using an approximate time based on the number of floors or vertical distance to be traveled.

As discussed further below, the system generates displays of the travel directions 208 which depict the total travel route and travel time, including ground-level and vertical portions. In some embodiments, the display includes enlarged features (e.g., the destination street and/or destination building footprint) to represent the additional time necessary for vertical travel. In other embodiment, the display visually represents the entire route including ground-level travel, vertical travel (by elevator or otherwise), and any additional travel within a destination building. The displays may be illustrations of locations, actual photographic or video depictions of locations, or combinations of both.

The software for generating the travel directions 208 may receive and use map data from at least one database 210. The map data may include street navigation maps for any number of locations worldwide. The database 210 may further include building data including maps of buildings at the various locations. The building data may include data indicative of vertical travel features in one or more buildings including, e.g., elevator layouts, elevator speeds, and elevator wait-times. In some embodiments, the building data is used by the system to generate directions within buildings and to calculate or estimate vertical travel times within buildings.

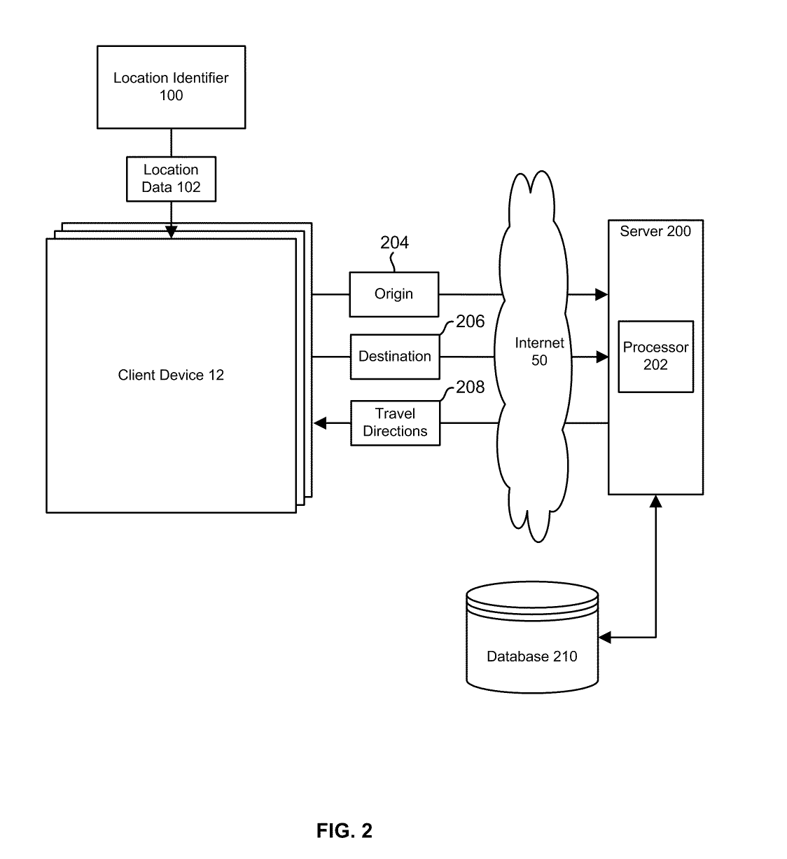

FIG. 2 further illustrates the mapping and directions system according to the present invention. In this embodiment, the system includes one or more client devices 12. A client device 12 may be, for example, a computer or a mobile device. The client device 12 may also be a vehicle mounted device such as a navigation system in an automobile, or a portable handheld navigation device. The client device 12 may include, and/or receive data from, the location identifier 100 to determine the current location of the client device 12. In the present embodiment, the processor 202 is included in a server 200 accessible to the client device 12 via the Internet 50.

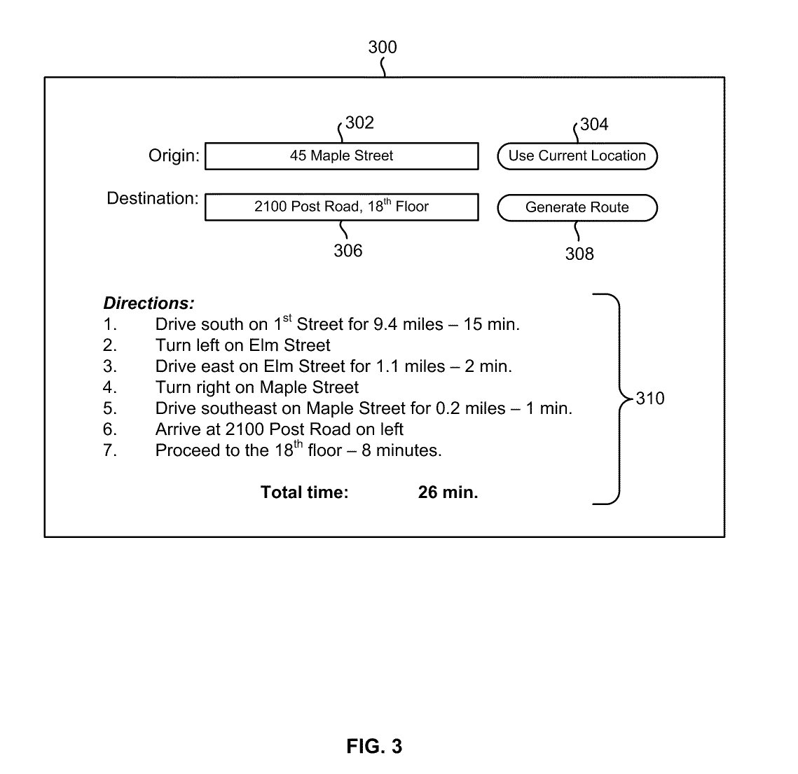

FIG. 3 illustrates an exemplary interactive display 300 or user interface generated by the system of FIGS. 1 and 2. The display 300 includes origin input field 302 and a button 304 to select a current location (e.g., of the client device 12). The display 300 further includes a destination input field 306 and button 308 to generate the travel directions. In the present display 300, the resulting travel directions are displayed as text directions 310.

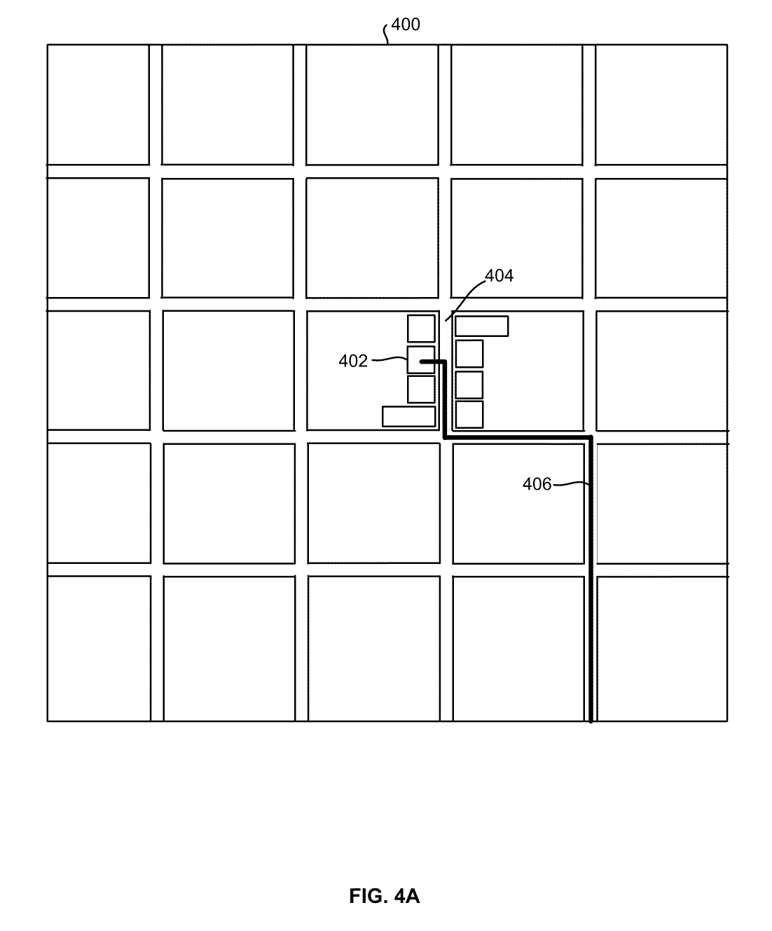

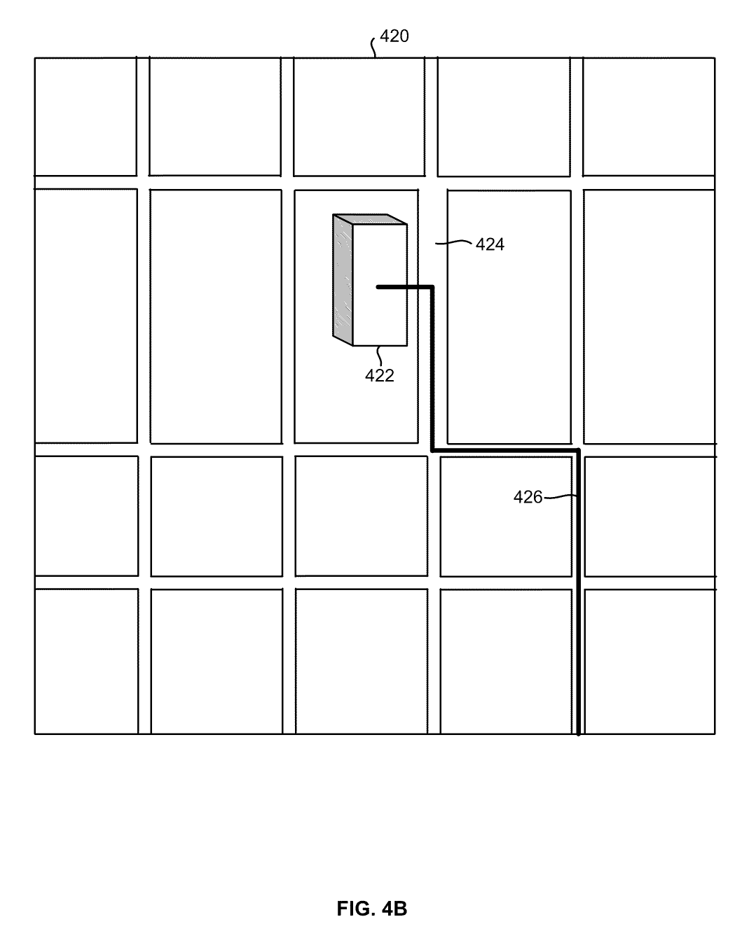

FIGS. 4A and 4B illustrate graphical displays 400/420 generated by the system of FIGS. 1 and 2. The displays 400/420 illustrate directions from an origin to a destination. In the display 400, travel to a non-elevated destination, such a one story building 402 or the first floor of a multi-level building 402, is illustrated. The display 420 illustrates directions to a destination on an elevated floor of a building 422. In the display 420, the size of the destination block 424 is enlarged based on the height of the destination. In particular, the block 424 is enlarged in proportion to the vertical travel distance and/or time required to reach the destination. Thus, the total travel distance and time is more accurately reflected. For example, in the exemplary display only destinations in one story buildings are shown to scale on the map. To walk to a meeting on, for example, the 50th floor of a building takes significantly more time than on the first floor. By more accurately reflecting distance traveled, the map more accurately predicts and illustrates travel time.

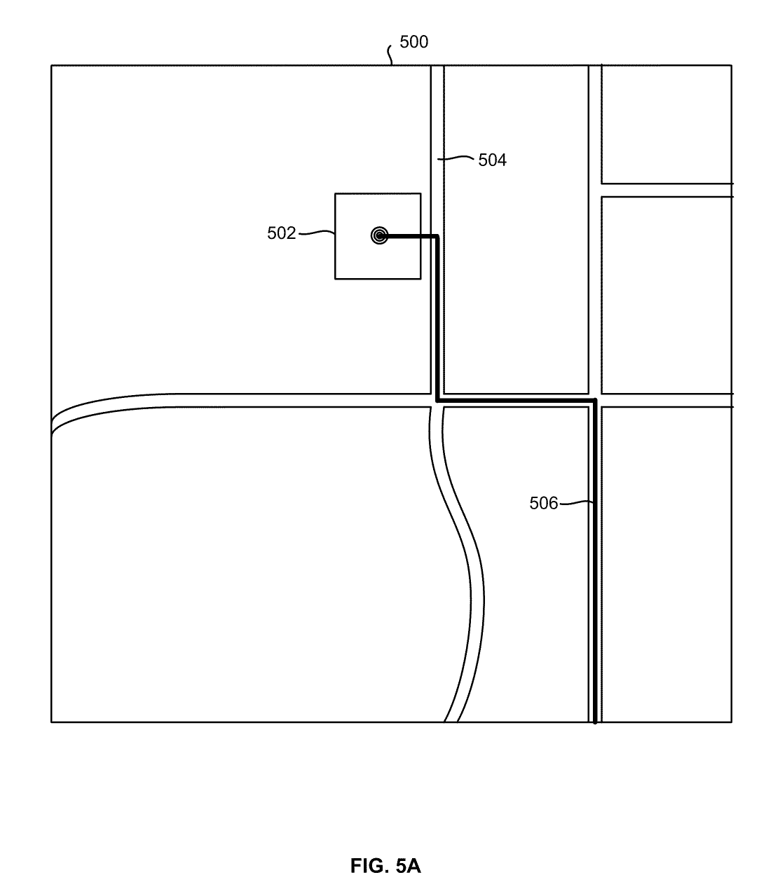

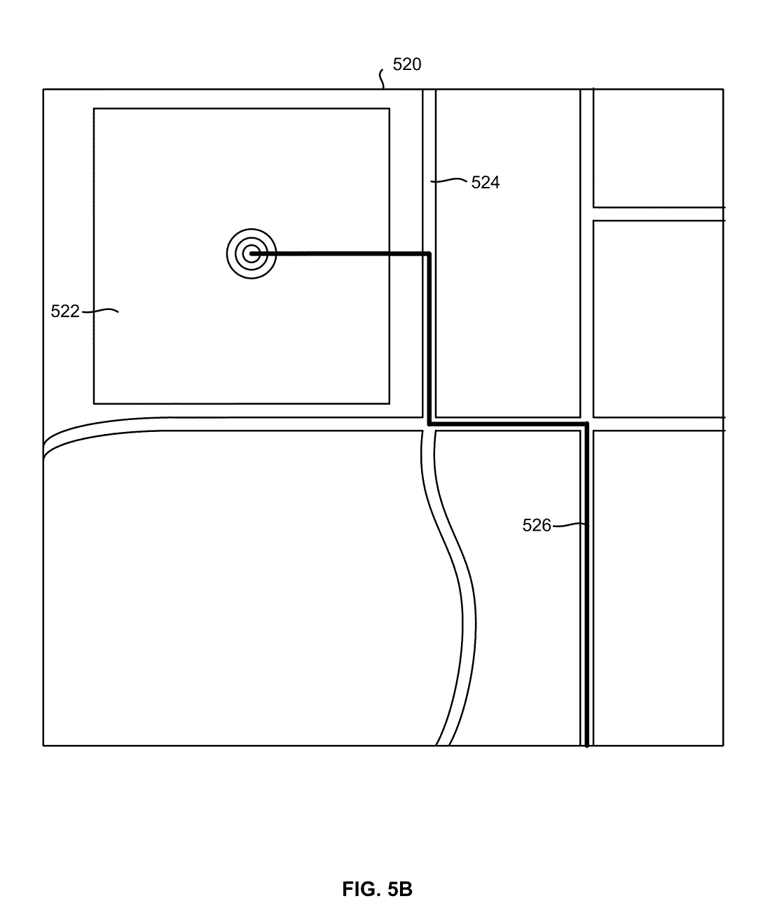

FIGS. 5A and 5B illustrate alternative graphical displays 500/520 generated by the system of FIGS. 1 and 2. The displays 500/520 illustrate directions from an origin to a destination. In the display 500, travel to a non-elevated destination, such a one story building 502 or the first floor of a multi-level building 502, is illustrated. The display 520 illustrates directions to a destination on an elevated floor of a building 522. In the exemplary display 520, the size or footprint of the destination building 522 is enlarged based on the height of the destination. The building 522 is enlarged in proportion to the vertical travel distance and/or time required to reach the destination to convey the additional time necessary for the user to reach the final destination.

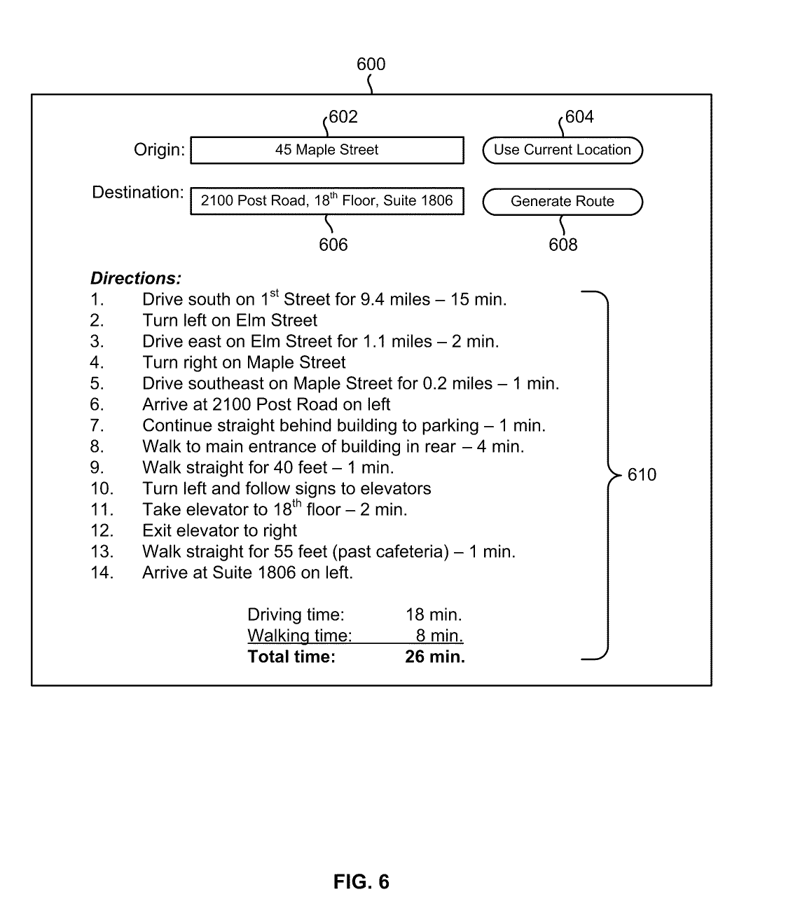

FIG. 6 illustrates another exemplary display 600 generated by the system of FIGS. 1 and 2. The display 600 includes origin input field 602 and a button 604 to select a current location (e.g., of the client device 12). The display 600 further includes a destination input field 606 and button 608 to generate the travel directions. The travel directions are displayed as text directions 610. In this example, the travel directions include direction to a particular office on an elevated floor within a building.

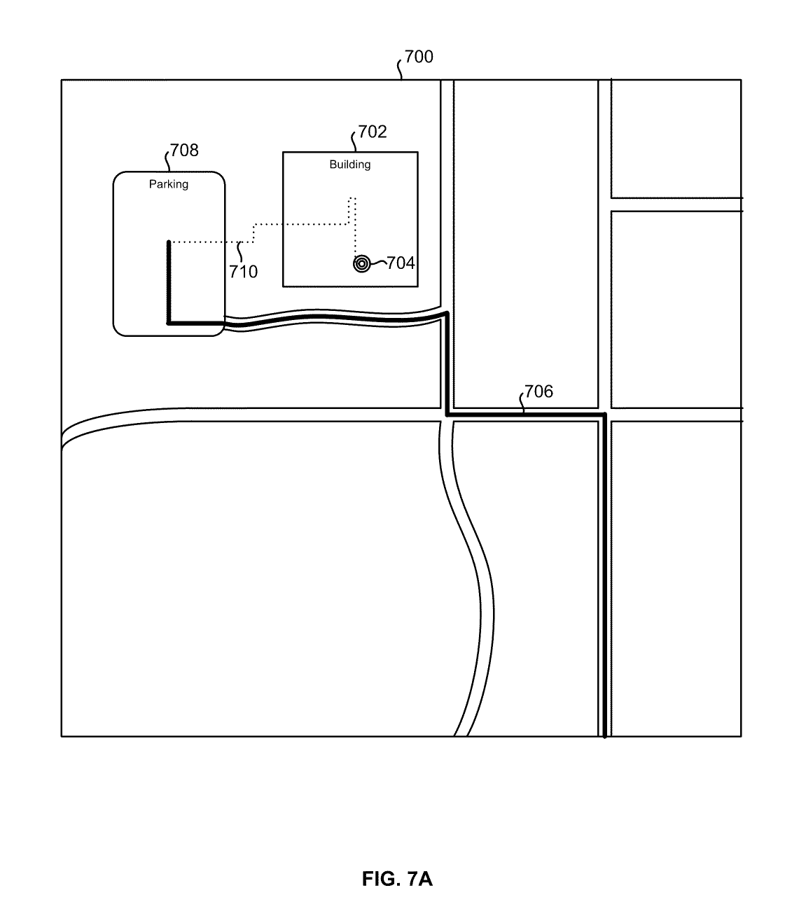

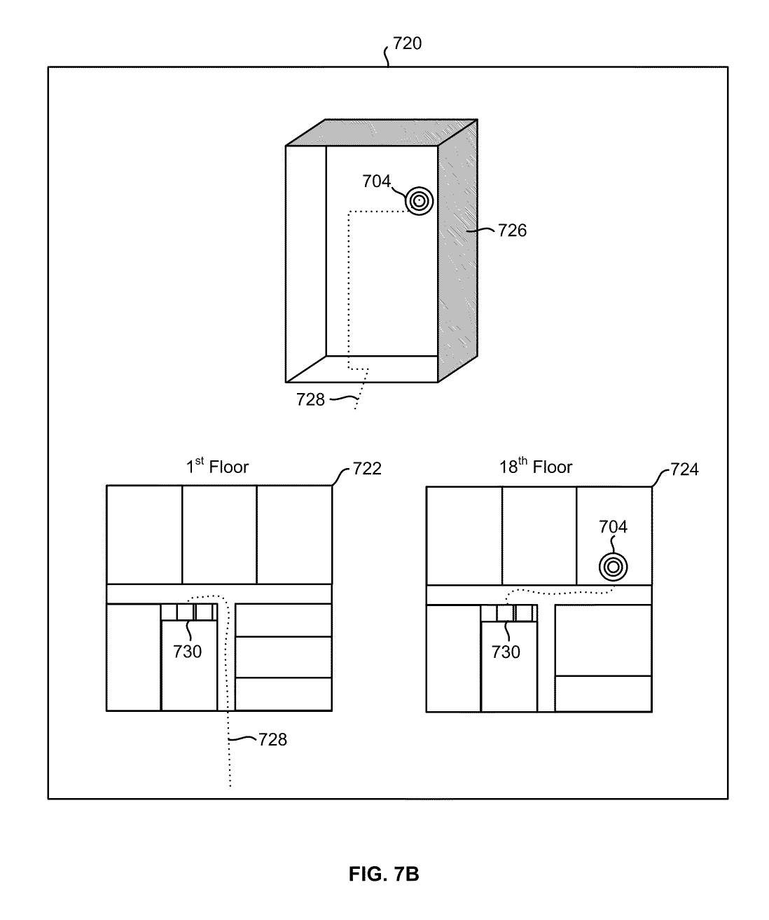

FIGS. 7A and 7B illustrate graphical displays 700/720 generated according to the text directions shown in FIG. 6. The graphical displays 700/720 illustrate turn-by-turn directions to an elevated final destination within a building showing each of the horizontal and vertical travel portions. Display 700 illustrates an aerial depiction of the travel route including a first ground-level portion 706. The travel route further includes a section portion 710 which may include one or more ground level portions, vertical portions, and horizontal portions to reach the destination 704. Display 720, shown in FIG. 7B, illustrates top views 722 and 725 of the travel route through an entrance floor and destination floor, respectively. Display 720 further includes a three-dimensional view 726 of the destination building and travel route to the destination 704. While the displays 700/720 show illustrations of the locations and buildings, the display generated by the system may further include photographic or video depictions of the locations and buildings, including actual photographic depictions of interior routes through buildings.

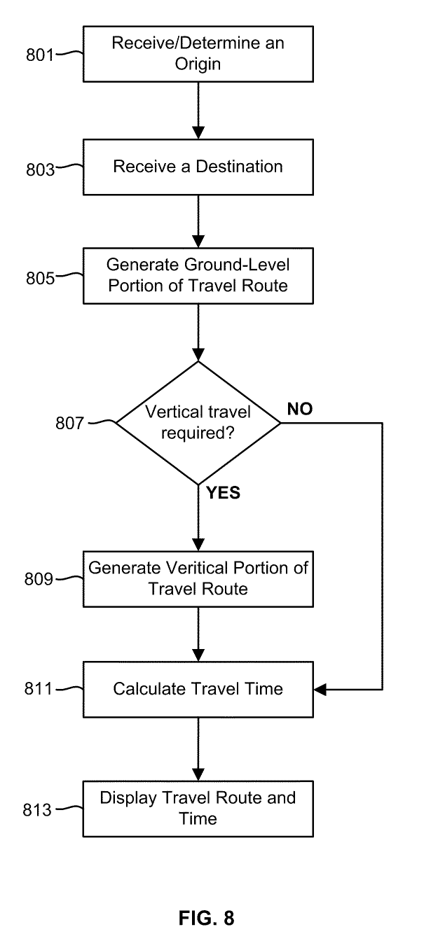

FIG. 8 illustrates a method of generating travel directions according to the present invention. The method includes the steps of receiving or determining an origin and a destination for a proposed travel route (steps 801-803). The origin may be entered by a user, or determined by a location identifier such as a GPS receiver. The method further includes the step of generating a ground-level portion of the travel route (step 805). For example, driving directions, walking directions, or a combination of both, may be generated to a destination address.

If vertical travel is also required for the travel route, either at the origin or destination, a vertical portion of the travel route is also generated (steps 807-809). This step may include generating a route to walk up/down an escalator or stairs, or take an elevator to a particular floor in a building. For example, the user may input what floor of the building he/she is coming from and/or going in order to receive a more accurately calculated travel time which takes into account the time for vertical travel. In some embodiments, the method also includes the step of generating additional horizontal portions of the travel route including, for example, horizontal travel on a destination floor of the building.

In step 811, the method calculates a travel time for the complete travel route, including any ground-level travel portions, any vertical travel portions, and any horizontal travel portions. Step 811 may be performed simultaneous with, or subsequent to, the generation of the travel routes. The ground-level travel times may be calculating by any means known in the art including but not limited to calculating a time based on the distance (e.g., as measured by street maps) and a travel speed (e.g., according to published speed limits, average walking speeds, etc.). The vertical travel time may be determined using an approximate time based on the number of floors or vertical distance to be traveled. In some embodiments, the method determines a vertical travel time using data indicative of elevator layouts, speeds, and wait-times for particular buildings. The method may also use data indicative of floor restrictions to further improve estimated travel time and shorten the trip by leading you to the right door and elevator bank.

In some embodiments, the method of FIG. 8 is embodied in a computer program product including a computer readable medium (e.g., database 210) having a controller and/or processor (e.g., processor 202) for causing a computer to generate travel directions according to computer readable program code indicative of the method steps. For example, such a computer program product may include computer readable program code for causing the computer to receive an origin and a destination, and computer readable program code for causing the computer to generate a travel route from the origin to the destination, the travel route including at least one ground-level travel portion and at least one vertical travel portion, calculate a travel time for the travel route from the origin to the destination, and provide a visual representation of the travel route, including the ground-level travel portions and the vertical travel portions, to a user via a user interface.

Although the invention has been described with reference to a particular arrangement of parts, features and the like, these are not intended to exhaust all possible arrangements or features, and indeed many modifications and variations will be ascertainable to those of skill in the art.

What is claimed is:

1. A mapping and directions system, comprising:
a processor;
software executing on said processor for receiving a geographical origin;
software executing on said processor for receiving a geographical destination;
software executing on said processor for generating a travel route from the origin to the destination, the travel route including at least one ground-level travel portion and at least one vertical travel portion; and
software executing on said processor for calculating a travel time for the travel route from the origin to the destination.

2. The system according to claim 1, wherein the at least one vertical travel portion includes at least one of elevator travel and escalator travel.

3. The system according to claim 1, further comprising:
software executing on said processor for providing a visual display of the travel route and the travel time.

4. The system according to claim 3, wherein one or more distances in the ground-level portion of the travel route are enlarged in scale in the visual display to represent additional distance and time to travel the at least one vertical portion.

5. The system according to claim 3, wherein the destination includes a particular floor in a building, wherein the visual display includes a representation of a footprint of the building, and wherein the footprint of the building is enlarged in scale in the visual display in proportion to at least one of the travel time and travel distance required to reach the particular floor.

6. The system according to claim 3, wherein the destination includes a particular floor in a building, wherein the visual display includes a three-dimensional representation of the building.

7. The system according to claim 1, wherein the at least one ground-level travel portion includes a walking route.

8. The system according to claim 1, wherein the at least one ground-level travel portion includes a driving route.

9. The system according to claim 1, further comprising:
a map database in communication with said processor, wherein said software for generating the travel route receives map data from said map database.

10. The system according to claim 9, wherein said maps database further includes data indicative of vertical travel features in one or more buildings including types of the vertical travel features and speeds of the vertical travel features.

11. The system according to claim 1, further comprising:
software executing on said processor for transmitting travel directions, including the travel route and the travel time, via the internet to at least one client device for display on the at least one client device.

12. The system according to claim 11, wherein the client device is one of a computer and a mobile device.

13. The system according to claim 1, wherein said software for receiving the geographical origin receives the origin from a global positioning system receiver in a client device.

14. The system according to claim 1, wherein the geographical destination is a location within a building, wherein the geographical destination including a horizontal location and a vertical location.

15. The system according to claim 14, wherein the geographical destination is a particular office in the building.

16. The system according to claim 1, wherein the travel route further includes at least one horizontal travel portion which follows the at least one vertical travel portion.

17. A mapping and directions system, comprising:
a processor;
software executing on said processor for generating travel directions, including a travel route and a travel time, from a geographical origin to a geographical destination;
the travel directions including at least one ground-level travel portion and at least one vertical travel portion; and
software executing on said processor for generating a visual display of the travel directions, wherein one or more features on the visual display of the travel route are enlarged in scale in proportion to at least one of a distance and a portion of the travel time required to travel the at least one vertical portion of the travel route.

18. The system according to claim 17, wherein the destination is a particular room on an elevated floor within a building, wherein the travel directions includes directions to the particular room.

19. The system according to claim 17, further comprising:
at least one database in communication with said processor, said database including map data and data indicative of vertical travel features in one or more buildings, wherein said software for generating the travel directions receives the map data and the data indicative of the vertical features from said map database.

20. The system according to claim 19, wherein the data indicative of vertical travel features includes data indicative of elevator layouts, elevator speeds, and elevator wait-times.

21. The system according to claim 17, further comprising at least one mobile device, wherein the geographical origin is determined by the at least one mobile device.

22. The system according to claim 17, wherein the geographical destination is a location within a building, wherein the geographical destination including a horizontal location and a vertical location.

23. The system according to claim 22, wherein the geographical destination is a particular office in the building.

24. A method of providing travel directions, comprising the steps of:
receiving an origin;
receiving a destination;
generating a travel route from the origin to the destination, the travel route including at least one ground-level travel portion and at least one vertical travel portion;
calculating a travel time for the travel route from the origin to the destination; and
providing a visual representation of the travel route, comprising the ground-level travel portions and the vertical travel portions, and the travel time to a user via a user interface.

25. The method of providing travel directions according to claim 24, wherein the step of calculating the travel time includes receiving data indicative of vertical travel features in one or more buildings.

26. A method of providing travel directions according to claim 24, wherein the visual representation of the travel route includes one or more ground-level features enlarged in scale in proportion to at least one of a distance and a time required to travel the at least one vertical portion of the travel route.
